(19) United States
(12) Patent Application Publication
(10) Pub. No.: US 2013/0313447 A1
(43) Pub. Date: Nov. 28, 2013

(54) OPTO-COUPLER

(71) Applicant: Avago Technologies General IP (Singapore) Pte. Ltd., Singapore (SG)

(72) Inventors: Thiam Siew Gary Tay, Singapore (SG); Premkumar Jeromerajan, Singapore (SG); Gopinath Maasi, Singapore (SG)

(73) Assignee: Avago Technologies General IP (Singapore) Pte. Ltd., Singapore (SG)

(21) Appl. No.: 13/959,464

(22) Filed: Aug. 5, 2013

Related U.S. Application Data
(63) Continuation-in-part of application No. 13/314,023, filed on Dec. 7, 2011.
Application No. 13/314,023 is a continuation-in-part of application No. 12/945,474, filed on Nov. 12, 2010.
Application No. 12/945,474 is a continuation-in-part of application No. 12/729,943, filed on Mar. 23, 2010, now Pat. No. 8,412,006.

(51) Int. Cl. H04B 10/80

(52) U.S. Cl. CPC H04B 10/802
USPC 250/551

(57) ABSTRACT

An optoelectronic device is disclosed. The optoelectronic device may be employed as a single or multi-channel opto-coupler that electrically isolates one circuit from another circuit. The opto-coupler may include one or more light guides and an insulative tape that helps define a shape of the one or more light guides.

### CROSS-REFERENCE TO RELATED APPLICATIONS

This is a continuation-in-part of U.S. application Ser. No. 13/314,023, filed on Dec. 7, 2011, which is a continuation-in-part of U.S. application Ser. No. 12/945,474, filed on Nov. 12, 2010, which is a continuation-in-part of U.S. application Ser. No. 12/729,943, filed on Mar. 23, 2010, each of which are incorporated by reference herein in their entirety.

### FIELD OF THE DISCLOSURE

The present disclosure is generally directed toward optoelectronic devices and, in particular, opto-coupling devices.

### BACKGROUND

In electronics, an opto-coupler, also referred to as an opto-isolator, photocoupler, or optical isolator, is an optoelectronic device designed to transfer electrical signals by utilizing light waves to provide coupling with electrical isolation between its input and output. One goal of an opto-coupler is to prevent high voltages or rapidly changing voltages on one side of the circuit from damaging components or distorting transmissions on the other side.

Generally, an opto-coupler comprises a light source (e.g., an optical transmitter die) and a light detector (e.g., an optical receiver die). The optical transmitter die and the optical receiver die may be housed in a single package. A multichannel opto-coupler may have more than one pair of optical transmitter or receiver dies. A signal is usually transmitted from the optical transmitter die to the optical receiver die. In order to prevent light loss, a light guide may be employed. In most cases, the light guide is formed by dispensing a transparent encapsulant in liquid form over the optical transmitter and receiver dies. The transparent encapsulant is then hardened through a curing process, thereby forming a light guide. Because the encapsulant is deposited in liquid form, the shape of the light guide may be difficult to control. This issue of controlling the light guide shape may be more severe for an opto-coupler with large dies or for a multichannel opto-coupler.

### BRIEF DESCRIPTION OF THE DRAWINGS

The present disclosure is described in conjunction with the appended figures, which are not necessarily drawn to scale:

FIG. 1 is a cross-sectional view of an opto-coupler in accordance with embodiments of the present disclosure;

FIG. 2A is a top view of an opto-coupler component in accordance with embodiments of the present disclosure;

FIG. 2B is a cross-sectional view of the opto-coupler component depicted in FIG. 2A;

FIG. 3A is a top view of an opto-coupler component in accordance with embodiments of the present disclosure;

FIG. 3B is a cross-sectional view of the opto-coupler component depicted in FIG. 3A;

FIG. 4A is a top view of an opto-coupler component in accordance with embodiments of the present disclosure;

FIG. 4B is a cross-sectional view of the opto-coupler component depicted in FIG. 4A;

FIG. 5A is a top view of an opto-coupler component in accordance with embodiments of the present disclosure;

FIG. 5B is a cross-sectional view of the opto-coupler component depicted in FIG. 5A;

FIG. 6A is a top view of an opto-coupler component in accordance with embodiments of the present disclosure;

FIG. 6B is a cross-sectional view of the opto-coupler component depicted in FIG. 6A; and

FIG. 7 is a flow chart depicting a method of manufacturing one or multiple opto-couplers in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

It is, therefore, one aspect of the present disclosure to provide an improved opto-coupler design that overcomes and addresses the above-mentioned issues. While examples discussed herein will be generally directed toward opto-couplers, it should be appreciated that the embodiments of the present disclosure are not so limited. For instance, the concepts described herein can be utilized in any type of isolator or isolation system (e.g., galvanic isolators), proximity sensors, optical encoders, or any other type of optical or non-optical device.

In some embodiments of the present disclosure an opto-coupler is provided with a light guide situated between the light source and the light detector. In some embodiments, the opto-coupler is provided with a light source, a light detector, and an encapsulant forming a light guide between the light source and the light detector, the encapsulant being at least partially supported by insulation or an insulative tape. In some embodiments, the light guide and the insulative tape on which the light guide is supported do not conduct electricity in much the same way to traditional insulation materials. An advantage to utilizing the insulative tape to at least partially support the encapsulant material is that the encapsulant can be deposited in a liquid or semi-liquid state and the insulative tape helps to maintain a desired form of the light guide even while the encapsulant is in a liquid or semi-liquid state.

In some embodiments, the encapsulant comprises an inherent surface tension and the shape of the encapsulant is at least partially dictated by the shape of the insulative tape. Specifically, the encapsulant, when deposited, may flow to the boundaries of the insulative tape and then begin forming a dome shape whose outer boundaries match or partially match the outer boundaries of the insulative tape. In this way, the insulative tape can be used to control how far the encapsulant flows during deposition and can maintain the shape of the encapsulant until the encapsulant is cured or hardened. In particular, the surface tension of the encapsulant causes the encapsulant to stop or slow flowing beyond the boundaries of the insulative tape.

In some embodiments, the encapsulant may correspond to a silicone or Ultraviolet-curable medium that is transparent or semi-transparent to light. The insulative tape may correspond to a polyimide film, a plastic tape, or a similar insulative material that can be formed into any desired shape. In particular non-limiting embodiments, the insulative tape may comprise one or more of Mylar, Polyimide, Kapton, Melinex, a dielectric tape, or any other similar material that is attachable to a leadframe, conductive element, or the like.

In some embodiments, the insulative tape provides the additional benefit of impeding a high-voltage failure path between a lead supporting the light source and a lead supporting the light detector. In particular, the insulative tape provides further insulative properties between conductive leads that are designed to be isolated from one another. Thus, the insulative tape can provide multiple benefits without substantially increasing manufacturing complexity or costs.

In some embodiments, a multi-channel opto-coupler is provided where one, two, three, four or more channels in the opto-coupler have a light guide situated between a light source and light detector of each channel. Each channel of the opto-coupler may have its own dedicated encapsulant or a single encapsulant may be provided around two or more sets of light sources and light detectors.

Additional details related to opto-couplers, including multi-channel opto-couplers, and their design are described in U.S. Patent Publication No. 2011/0235975 and U.S. Patent Publication No. 2012/0076455, each of which are hereby incorporated herein by reference in their entirety.

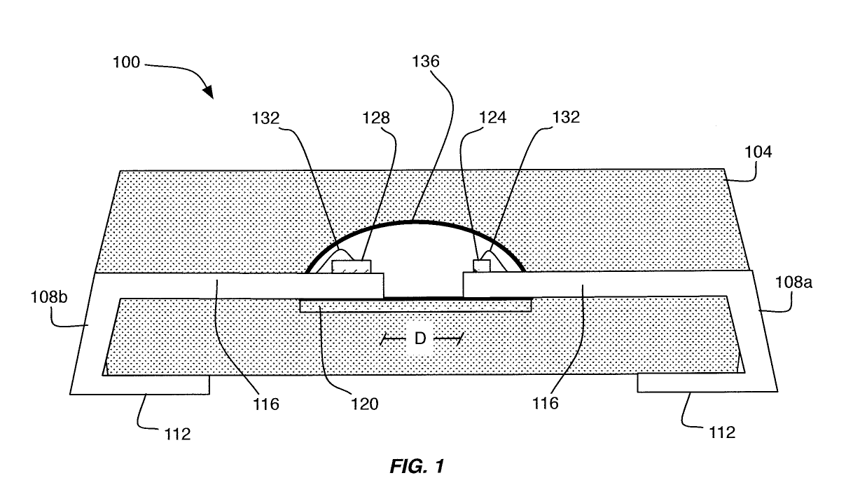

With reference now to FIGS. 1-6B, various opto-couplers and components thereof will be described in accordance with embodiments of the present disclosure. While most of the embodiments described herein relate to a single-channel opto-coupler, it should be appreciated that embodiments of the present disclosure are not so limited. In particular, those of ordinary skill in the art will appreciate that the concepts disclosed herein can be applied to multi-channel opto-couplers.

As can be seen in FIGS. 1-6B, various configurations of optoelectronic devices, opto-couplers, and intermediate opto-coupler configurations are depicted and described. Although some of the opto-couplers depicted in the figures correspond to opto-couplers at intermediate stages of manufacturing, one of ordinary skill in the art will appreciate that any of the intermediate products described herein can be considered an opto-coupler. In other words, one or more of the optoelectronic devices may be employed as opto-couplers or as components within a coupling system. In some embodiments, the opto-coupler devices described herein may be incorporated into any system which requires current and/or voltage monitoring, but is susceptible to transients. In some embodiments, the coupling system in which the opto-coupler devices described herein is rated to operate at about 5 kV, 10 kV, or more. Stated another way, the input side (e.g., a high-voltage side) of the opto-coupler device may be directly connected to a 5 kV, 10 kV, 15 kV or greater source without damaging the opto-coupler device or any electronic devices attached to the output side (e.g., a low-voltage side) of the opto-coupler device. Accordingly, the coupling system which employs the opto-coupler devices disclosed herein may be configured to operate in high-voltage or high-current systems but may also be configured to separate the high-voltage or high-current systems from a low-voltage or low-current system.

Referring initially to FIG. 1, an illustrative opto-coupler 100 will be described in accordance with embodiments of the present disclosure. The opto-coupler 100 is shown to include a housing 104, a leadframe comprising a plurality of leadframe sections 108a, 108b, a light source 124, a light detector 128, insulative tape 120, and an encapsulant 136.

In some embodiments, the encapsulant 136 operates as a light guide or light-transmission medium to facilitate the passage of light from the light source 124 to the light detector 128. As is known in the opto-coupler arts, the light source 124 may activate or respond to electrical current or voltage present on a lead 112 of the first leadframe section 108a. Upon being activated, the light source 124 may release photons, which travel through the encapsulant 136 where they can be detected at the light detector 128. The light detector 128 then converts the light energy received at the light detector 128 back into an electrical signal that can be carried by another lead 112 of the second leadframe section 108b.

As shown in FIG. 1, there is a distance D through the insulative encapsulant 136. This distance D may correspond to a distance through insulation or DTI. The distance D represents the shortest path between the conductive leads 112 of the first leadframe section 108a and second leadframe section 108b. In particular, the distance D usually correspond to the shortest linear distance between a bonding pad portion 116 of a lead 112 on which the light source 124 is mounted and a bonding pad portion 116 of a lead 112 on which the light detector 128 is mounted. This shortest linear distance between bonding pads 116 usually represents the most common point of a high-voltage failure (e.g., electrical arc) in an opto-coupler 100. Accordingly, most opto-couplers 100 are designed to maximize the distance D without negatively impacting the signal transmission between the light source 124 and light detector 128. As can be appreciated, however, as the distance D increases, the possibility of a high-voltage failure increases whereas the signal losses through the encapsulant 136 increase. In other words, the selection of the distance D must weigh the increased distance D with the potential losses of signal or with an increased signal-to-noise ratio.

The input side of the opto-coupler 100 may correspond to the first leadframe section 108a and one, some, or all leads 112 of the first leadframe section 108a may be configured for attachment to a circuit whose current and/or voltage is being measured. Conversely, the output side of the opto-coupler may correspond to the second leadframe section 108b and one, some, or all leads 112 of the second leadframe section 108b may be configured for attachment to circuitry operating at lower voltages and/or currents. As an example, the second leadframe section 108b may be connected to sensitive measurement and/or control circuitry. The gap between the first leadframe section 108a and second leadframe section 108b is generally provided to electrically insulate the currents/voltages at the input circuit from the output circuit.

The first leadframe section 108a and second leadframe section 108b may each comprise one or more electrically conductive leads 112. Moreover, although the shape of the leads 112 is shown to be configured for surface mounting (e.g., Surface Mount Technology (SMT)), it should be appreciated that the leads 112 may be straight or otherwise configured for thru-hole mounting to a Printed Circuit Board (PCB). In some embodiments, the leadframe may be initially provided as a sheet of conductive material having portions removed therefrom to establish discrete conductive elements or features (e.g., leads 112, bonding pads 116, etc.). The conductive elements of the leadframe including the leads 112 of both leadframe sections 108a, 108b may be constructed of metal (e.g., copper, silver, gold, aluminum, steel, lead, etc.), graphite, and/or conductive polymers.

The leads 112 of each leadframe section 108a, 108b may comprise a first end and second end and one or more of the leads 112 may further include an expanded area corresponding to the bonding pad 116. In some embodiments, the first end of each lead 112 may be contained within the housing 104 whereas the second end of each lead 112 may be exposed outside the housing 104. Thus, the first end of a lead 112 may be connected to internal circuitry or components of the opto-coupler 100 whereas the second end of a lead 112 may be connected to external circuitry, such as a PCB. Each lead 112 may also have one or more bends between their first end and second end, thereby establishing the shape of each lead 112 in the finished opto-coupler 100. In some embodiments, the bends and the length of the leads 112 extending beyond the housing 104 may be adjusted to suit the particular type of device to which the opto-coupler 100 will be connected. In other words, although embodiments of the present disclosure show the leads as having a specific configuration (e.g., SMT configurations), it should be appreciated that the leads or relevant sections protruding from the housing 104 may comprise any type of known, standardized, or yet-to-be developed configuration such as straight-cut leads, J leads, SOJ leads, gullwing, reverse gullwing, etc.

The housing 104 may be constructed of any material that is sufficient to protect internal components of the opto-coupler 100 and/or substantially prevent external light from reaching the optical pathway between the light source 124 and light detector 128, thereby introducing noise to the device. The housing 104, in some embodiments, may comprise non-conductive or insulative properties. Suitable types of materials that may be used as the housing 104 include, without limitation, plastic, ceramic, any substantially opaque or black compound, a white epoxy, any polymer or combination of polymers, any malleable or formable opaque material, or combinations thereof. The housing 104 may be manufactured using extrusion, machining, micro-machining, molding, injection molding, or a combination of such manufacturing techniques.

In some embodiments, the optical components of the opto-coupler 100 may be mounted directly on the leads 112, which extend out of housing 104. As an example, the light source 124 may be mounted on a bonding pad 116 of one lead 112 in the first leadframe section 108a and the light detector 128 may be mounted on a bonding pad 116 of a lead in the second leadframe section 108b. The mounting of optical components to a bonding pad 116 may be achieved by utilizing one or more of welding, adhesives, glue, mechanical structures (e.g., friction fits), etc.

In some embodiments, the encapsulant 136 corresponds to a transparent encapsulant and may be constructed of one or more of epoxy, silicone, a hybrid of silicone and epoxy, phosphor, a hybrid of phosphor and silicone, an amorphous polyamide resin or fluorocarbon, glass, plastic, or combinations thereof. In some embodiments, the encapsulant 136 may be deposited over the light source 124 and light detector 128 as well as wire bonds 132 connecting the optical components 124, 128 to the leads 112. Even more specifically, the encapsulant 136 may be deposited over the optical components 124, 128 and wire bonds 132 in a liquid or semi-liquid state and, thereafter, may be cured or hardened. As can be appreciated, the advantage to depositing an encapsulant 136 in a liquid or semi-liquid state is that it can be easily applied by a number of deposition processes. However, the downside to depositing an encapsulant 136 in a liquid or semi-liquid state is that it is difficult to control the shape of the encapsulant 136 until it is cured or hardened.

Previous solutions have attempted to control the shape of the encapsulant 136 with the use of forming elements (e.g., miniature molds or retaining structures). The present disclosure, on the other hand, suggests utilizing the insulative tape 120 as a mechanism for controlling the shape of the encapsulant 136 during deposition and after deposition until the encapsulant 136 is cured or hardened. As will be discussed herein, the insulative tape 120 may be utilized as the sole mechanism for controlling the shape of the encapsulant 136 prior to its curing or hardening.

Achieving a controllable and repeatable shape of the encapsulant 136 provides many advantages. First of all, if the shape of the encapsulant 136 can be maintained substantially constant from one opto-coupler 100 to another and from one manufacturing batch to another, the light transmission behavior of opto-couplers 100 can be more carefully controlled, thereby providing better and more consistent opto-couplers 100. Additionally, if the encapsulant 136 were to deform and not completely cover the optical components 124, 128 and/or wire bonds 132, then other failures may occur, thereby decreasing yield and profits. Further still, if the encapsulant 136 does not have a desired shape (e.g., smooth upper surface and flat lower surface), then the light path between the light source 124 and light detector 128 may be disrupted or non-optimal and the light emitted by the light source 124 may not completely arrive at the light detector 128. Thus, it is important to provide a mechanism for controlling the shape of the encapsulant 136, but it is also desirable to avoid any additional or complicated manufacturing steps.

In some embodiments, the light source 124 corresponds to a surface mount LED, a traditional LED (e.g., with pins for thru-hole mounting), an array of LEDs, a laser diode, or combinations thereof. The light source 124 is configured to convert electrical signals (e.g., current and/or voltage) from one or more leads 112 of the first leadframe section 108a into light. The light emitted by the light source 124 may be of any wavelength (e.g., either in or out of the visible light spectrum).

In some embodiments, the light detector 128 corresponds to device or collection of devices configured to convert light or other electromagnetic energy into an electrical signal (e.g., current and/or voltage). Examples of a suitable light detector 128 include, without limitation, a photodiode, a photoresistor, a photovoltaic cell, a phototransistor, an Integrated Circuit (IC) chip comprising one or more photodetector components, or combinations thereof. Similar to the light source 124, the light detector 128 may be configured for surface mounting, thru-hole mounting, or the like.

In some embodiments, one surface of the light source 124 is an anode and another surface of the light source 124 is a cathode. One of the anode and cathode may be electrically connected to the bonding pad 116 and the other of the anode and cathode may be electrically connected to a different lead 112 via a wire bond 132. By creating a potential between the anode and cathode of the light source 124, the light source 124 may be configured to emit light of a predetermined wavelength. It should be appreciated that not every lead 112 on the first leadframe section 108a needs to be connected either physically or electrically with the light source 124.

Like the light source 124, the light detector 128 may be mounted on a boding pad 116 of the second leadframe section 108b and may be electrically connected to another lead 112 via a wire bond 132.

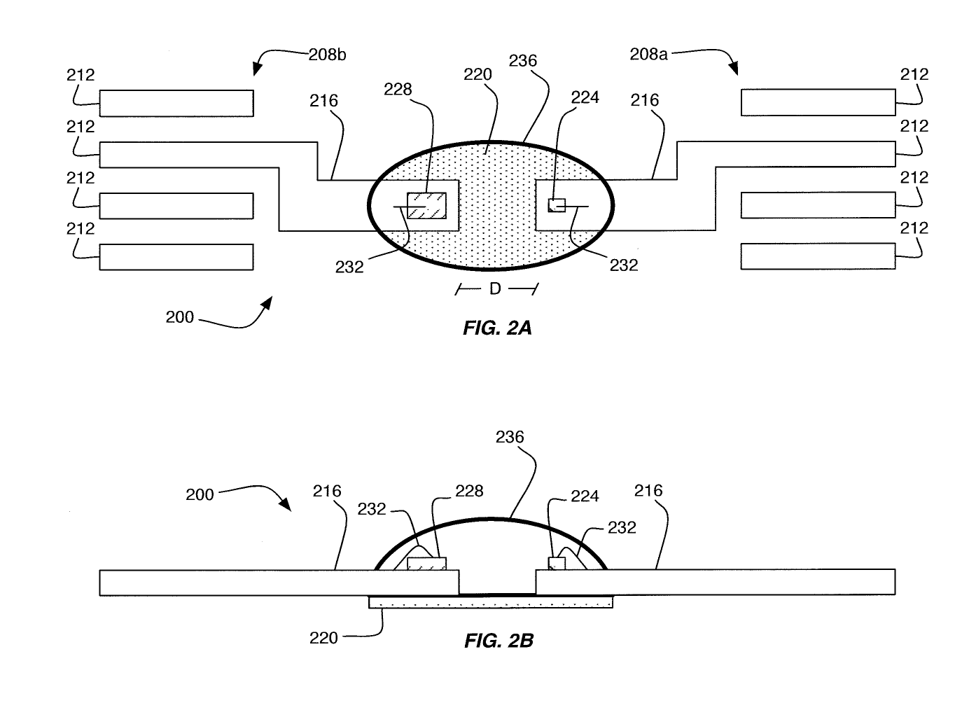

With reference now to FIGS. 2A and 2B, additional details of an opto-coupler component 200 that may be used in the opto-coupler 100 will be described in accordance with embodiments of the present disclosure. The opto-coupler component 200 is shown to include a first leadframe section 208a and second leadframe section 208b, each comprising a plurality of leads 212, which may be similar or identical to the leadframe sections 108a, 108b and leads 112, respectively. As shown in FIG. 2A, one or more leads 212 on the first leadframe section 208a may comprise a bonding pad 216. Furthermore, one or more leads 212 on the second leadframe section 208b may comprise a bonding pad 216. Each bonding pad 216 may be configured to have an optical component or multiple optical components mounted thereto. Specifically, a light source 224 may be mounted on a bonding pad 216 of the first leadframe section 208a and a light detector 228 may be mounted on a bonding pad 216 of the second leadframe section 208b. The light source 224 and light detector 228 may be similar or identical to the light source 124 and light detector 128, respectively.

FIG. 2A further depicts one illustrative shape of an insulative tape 220 that may be used to control the encapsulant 236 prior to curing or hardening the encapsulant 236. Specifically, the insulative tape 220 and encapsulant 236 may be similar or identical to the insulative tape 120 and encapsulant 136 described in connection with FIG. 1. In the depicted embodiment, the adhesive or sticky side of the insulative tape 220 corresponds to the top surface and allows the insulative tape 220 to be adhered to the bonding pads 116. Furthermore, as will be discussed herein, the sticky side of the insulative tape 220 may also correspond to the side on which the encapsulant 236 is deposited and the adhesive material on the insulative tape 220 may help to prohibit the encapsulant 236 from flowing beyond the boundaries of the insulative tape 220.

The insulative tape 220 of FIGS. 2A and 2B is shown to have an elliptical or oval shape that extends past the light source 124 and light detector 128. Furthermore, the minor axis of the insulative tape 220 is shown to be wider than a width of the bonding pads 216. Said another way, the major axis or transverse diameter of the insulative tape 220 may be larger than the distance D and may even be larger than a distance between the optical components 224, 228, whereas the minor axis or conjugate diameter of the insulative tape 220 may be larger than a width of the boding pads 216. In some embodiments, it may also be desirable to position the light source 224 at one foci of the elliptical insulative tape 220 and position the light detector 228 at the other foci of the elliptical insulative tape, although such a configuration is not required. It should also be appreciated, however, that the insulative tape 220 does not necessarily have to extend beyond the optical components 224, 228 or have a conjugate diameter that is greater than a width of the bonding pads 216. Further still, it should be appreciated that a circular shape may be used for the insulative tape 220 without departing from the scope of the present disclosure.

As shown in FIG. 2A, the outer boundary of the encapsulant 236 substantially coincides with the outer boundary of the insulative tape 220. In some embodiments, the insulative tape 220 is positioned at a bottom surface of the bonding pads 216 and in some cases it may even be attached or adhered to the bottom surface of the bonding pads 216. Once the insulative tape 220 is in the desired position relative to the bonding pads 216 (and optical components 224, 228), the encapsulant 236 may be deposited on the top surface of the insulative tape 220, thereby covering at least some of the boding pads 216 as well as the optical components 224, 228 and the wire bonds 232 connecting the optical components 224, 228 to the leads 212. Under the force of gravity the liquid or semi-liquid encapsulant 236 will attempt to spread out and flatten across the deposition surface.

However, once the encapsulant 236 reaches the outer boundary of the insulative tape 220 the inherent surface tension of the encapsulant 236 may maintain the encapsulant 236 in a desired shape at the outer boundary of the insulative tape 220 and oppose further spreading of the encapsulant. Accordingly, the force of gravity and the inherent surface tension of the encapsulant 236 can be equalized with an appropriately sized insulative tape 220, thereby enabling the insulative tape 220 to control the size and shape of the encapsulant 236 in a liquid or semi-liquid state until such time that the encapsulant 236 is cured or hardened.

Of course, the amount of encapsulant 236 deposited will impact whether or not the encapsulant 236 stops flowing at the outer boundary of the insulative tape 220. Furthermore, the viscosity of the encapsulant 236 and/or the dimensions of the insulative tape 220 will dictate whether the encapsulant 236 stops flowing at the boundaries of the insulative tape 220. It is contemplated that any amount of encapsulant 236 or dimension of insulative tape 220 may be accommodated without departing from the scope of the present disclosure.

In some embodiments, the insulative tape 220 can be the sole light guide-shaping element, thereby obviating the need for additional shaping mechanisms or molds. In the depicted embodiment, the elliptical insulative tape 220 can be used to create a dome-shaped encapsulant 236 with a particular thickness. In some embodiments, the thickness or height of the dome-shaped encapsulant 236 (e.g., distance between the top surface of the insulative tape 220 and top of the encapsulant 236) may be less than or equal to the conjugate diameter of the insulative tape 220. In embodiments where the wire bonds 232 extend to a lead 212 other than the one where the optical component 224, 228 is mounted, the insulative tape 220 may be extended or expanded to ensure that the encapsulant 236 covers some or all of the wire bond 232 that extends to another lead 212. Thus, although the embodiment of FIGS. 2A and 2B show the insulative tape 220 only extending underneath two leads 212, it should be appreciated that the insulative tape 220 can be sized to extend underneath three, four, five, or more of the leads 212.

In some embodiments, the insulative tape 220 may correspond to a polyimide film, a plastic tape, and/or a similar insulative material that is substantially flat and capable of being formed into any desired shape. Accordingly, the bottom surface of the encapsulant 236 may be substantially flat and smooth where it interfaces with the insulative tape 220 and the top surface of the encapsulant 236 may be substantially curved and smooth since the only force that shaped the top surface of the encapsulant 236 was gravity. Furthermore, since the encapsulant 236 obtained was self-formed with the assistance of gravity, the encapsulant 236 can remain in its desired shape until it is cured or hardened without any additional retaining members or molds.

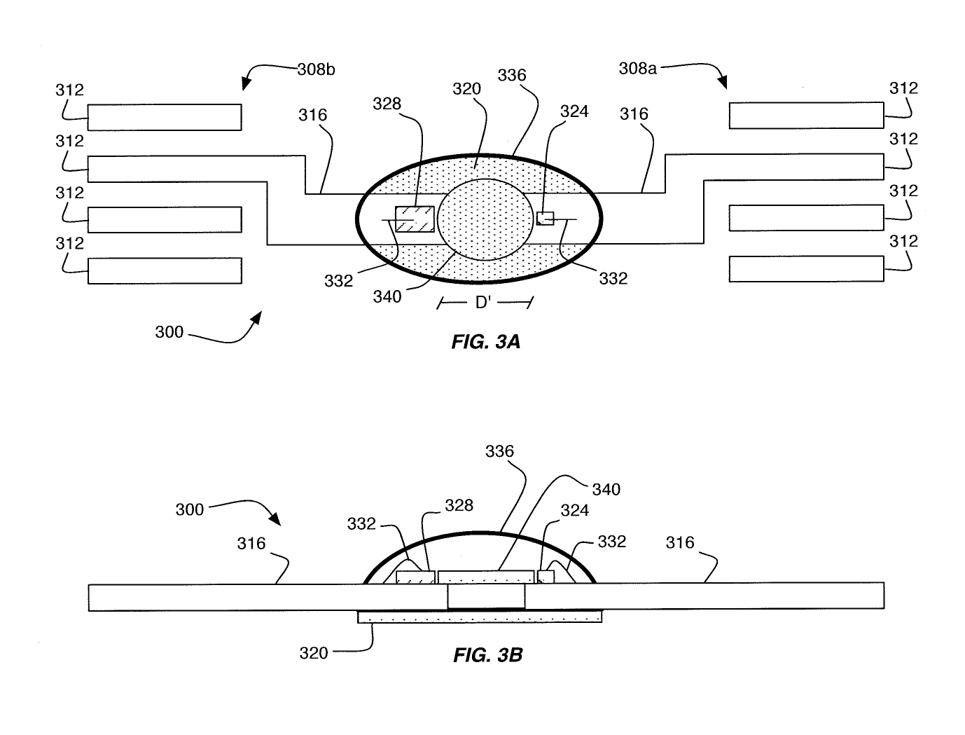

With reference now to FIGS. 3A and 3B, another illustrative opto-coupler component 300 will be described in accordance with embodiments of the present disclosure. The opto-coupler component 300 is similar to the opto-coupler component 200 in many respects except that the distance between leadframe sections 308a, 308b is increased to a distance D′ that is larger than the distance D thanks to the an additional insulative tape 340 being provided on the top surface of the bonding pads 316. The leadframe sections 308a, 308b, leads 312, bonding pads 316, insulative tape 320, light source 324, light detector 328, wire bond 332, and encapsulant 336 may be similar or identical to the leadframe sections 208a, 208b, leads 212, bonding pads 216, insulative tape 220, light source 224, light detector 228, wire bond 232, and encapsulant 236, respectively.

The additional insulative tape 340 may be constructed of a material similar or identical to the material used for the insulative tape 320. The position of the additional insulative tape 340, however, helps to increase the distance between the bonding pads 316. While the additional insulative tape 340 is shown as being provided on the top surface of the leadframe sections 308a, 308b, it should be appreciated that the bonding pads 316 of the leadframe sections 308a, 308b may be cut or punched to have a shape that corresponds or mimics the shape of the additional insulative tape 340. Accordingly, it may also be possible to position the additional insulative tape 340 directly on top of the insulative tape 320 and on the same plane as the bonding pads 316. Alternatively or additionally, it may be possible to utilize the additional insulative tape 340 without the insulative tape 320.

In the depicted embodiment, the additional insulative tape 340 comprises an elliptical or oval shape, although it should be appreciated that a circular or non-elliptical shape could also be employed. The additional insulative tape 340 may help to minimize high-voltage failures of the opto-coupler by increasing the distance between the input and output side of the opto-coupler. In other words, the insulative tape 320 and additional insulative tape 340 can be used to help shape the encapsulant 336, improve coverage of the encapsulant 336 as well as reduce metal exposure, which could ultimately result in high-voltage failure. In some embodiments, the insulative tape 320 may provide the function of controlling the shape of the encapsulant 336 whereas the additional insulative tape 340 may provide the function of reducing the potential for high-voltage failure.

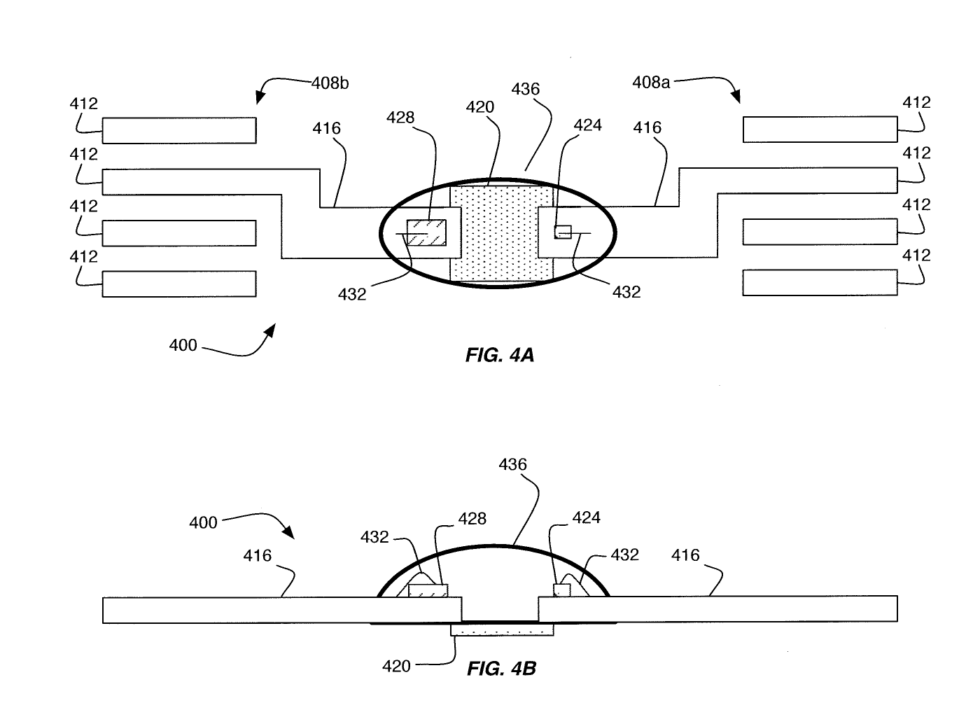

Referring now to FIGS. 4A and 4B, another illustrative opto-coupler component 400 will be described in accordance with embodiments of the present disclosure. The opto-coupler component 400 is similar to the opto-coupler component 200 depicted in FIGS. 2A and 2B except that the shape of the insulative tape 420 is different from the shape of the insulative tape 220. Otherwise, the material properties of the insulative tape 420 may be similar or identical to the material properties of the insulative tape 220. Furthermore, the leadframe sections 408a, 408b, leads 412, bonding pads 416, light source 424, light detector 428, wire bond 432, and encapsulant 436 may be similar or identical to the leadframe sections 208a, 208b, leads 212, bonding pads 216, light source 224, light detector 228, wire bond 232, and encapsulant 236, respectively.

As seen in FIG. 4A, the insulative tape 420 may comprise a polygonal shape, such as a triangular shape, rectangular shape, square shape, trapezoidal shape, parallelogram shape, rhombus shape, etc. Moreover, the insulative tape 420 does not necessarily have to extend beyond the optical components 424, 428. Instead, the insulative tape 420 may not even reach the optical components 424, 428 or it may only extend to the optical components 424, 428. Furthermore, the encapsulant 436 may not have its boundaries completely coincide with the outer boundaries of the insulative tape 420. Specifically, it is highly unlikely, but not impossible, that the encapsulant 436 would assume a square domed shape to match the surface area of the insulative tape 420; however, it may be possible that some of the outer boundaries of the insulative tape 420 still help to form or define the outer boundary of the encapsulant 436. For instance, the depicted example shows some corners of the insulative tape 420 coinciding with the outer boundary of the encapsulant 436.

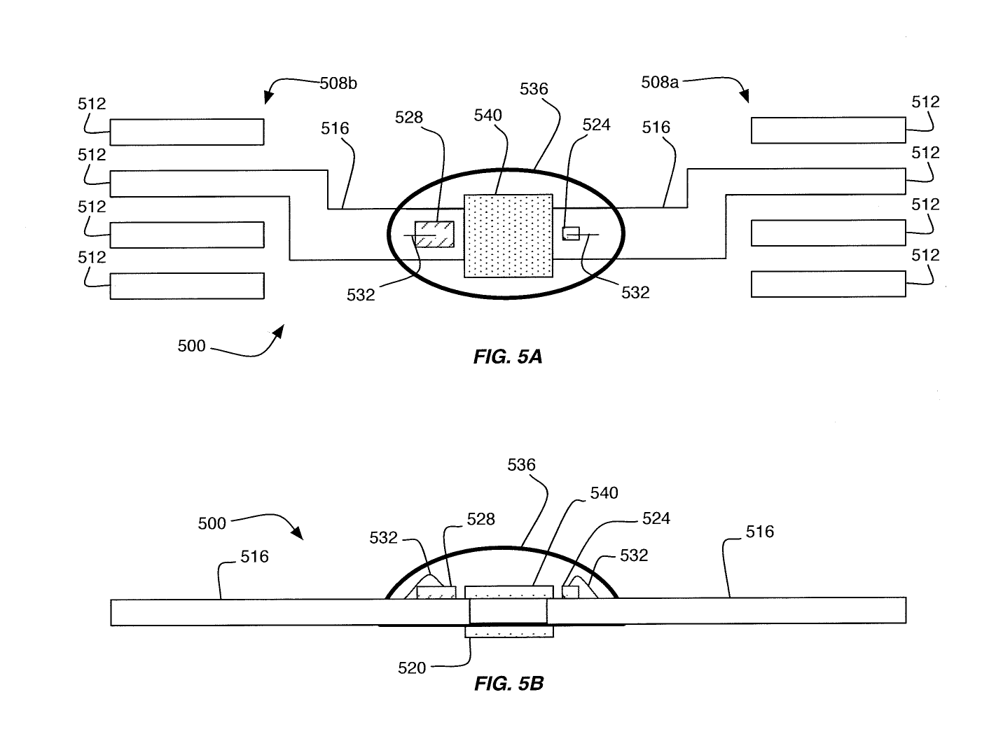

With reference now to FIGS. 5A and 5B, yet another opto-coupler component 500 will be described in accordance with embodiments of the present disclosure. The opto-coupler component 500 is similar to the opto-coupler component 300 depicted in FIGS. 3A and 3B except that the shape of the insulative tape 520 and additional insulative tape 540 are different from the shape of the insulative tape 320 and additional insulative tape 340. Another difference is that the additional insulative tape 540 comprises substantially the same shape and size as the insulative tape 520 whereas the additional insulative tape 340 was different in size and shape as compared to the insulative tape 320. In all other respects, the material properties of the additional insulative tape 540 and/or insulative tape 520 may be similar or identical to the material properties of the additional insulative tape 520 and/or insulative tape 220. Furthermore, the leadframe sections 508a, 508b, leads 512, bonding pads 516, light source 524, light detector 528, wire bond 532, and encapsulant 536 may be similar or identical to the leadframe sections 508a, 508b, leads 512, bonding pads 516, light source 524, light detector 528, wire bond 532, and encapsulant 536, respectively.

FIGS. 5A and 5B also depict an embodiment where both the insulative tape 520 and additional insulative tape 540 do not have any boundaries that coincide with the outer boundaries of the encapsulant 536. In such an embodiment, the encapsulant 536 may be deposited on a substrate or similar material that supports the leadframe sections 508a, 508b. Alternatively, the encapsulant 536 may be deposited on the leads 512 and insulative tapes 520, 540, but allowed to flow over and around the sides of the insulative tape 520 and possibly completely encapsulate the insulative tape 520 and additional insulative tape 540. Again, the shape of the encapsulant 536 may still be self-forming under the force of gravity and, therefore, a smooth but curved upper surface may be created for the encapsulant 536. This smooth and curved upper surface may enable the encapsulant 536 to efficiently transfer light from the light source 524 to the light detector 528.

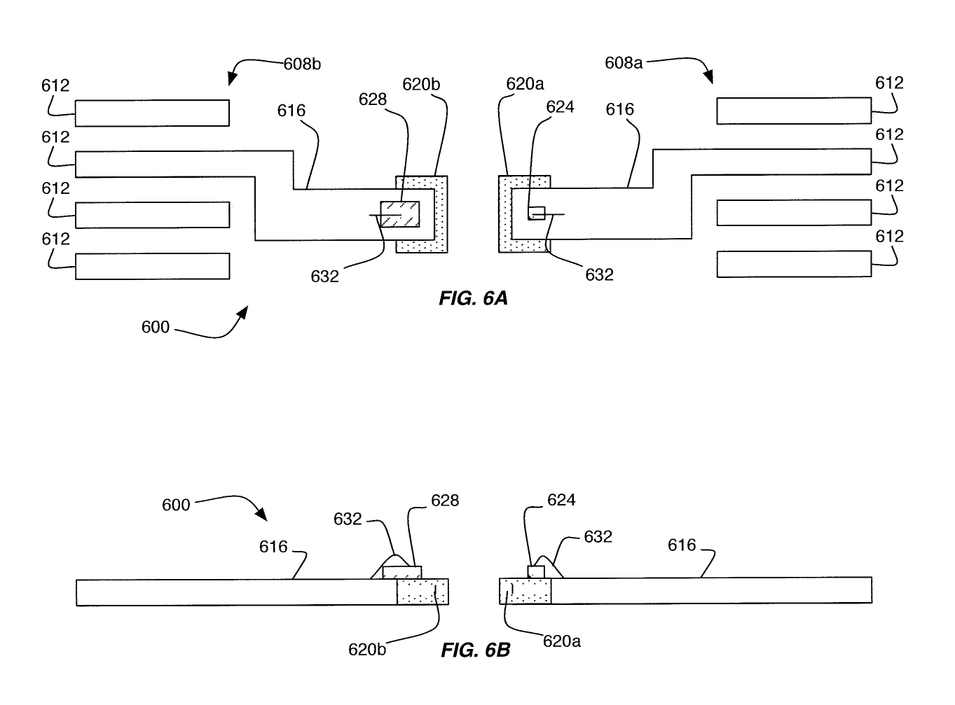

With reference now to FIGS. 6A and 6B, another example of an opto-coupler component 600 will be described in accordance with embodiments of the present disclosure. The opto-coupler component 600 exhibits the lack of a single piece of insulative tape to support an encapsulant. Instead the opto-coupler component 600 utilizes a first insulative portion 620a and second insulative portion 620b to provide additional electrical insulation between the bonding pads 616 of the leadframe sections 608a, 608b. The leadframe portions 608a, 608b, leads 612, bonding pads 616, light source 624, light detector 628, and wire bonds 632 may be similar or identical to any one or more of the leadframe portions, leads, bonding pads, light sources, light detectors, and wire bonds discussed herein above, respectively.

The first and second insulative portions 620a, 620b may partially or completely cover the side surface of each bonding pad 616 that faces the other bonding pad. In this way, the insulative portions 620a, 620b create a longer metal-to-metal distance between the bonding pads 616, thereby mitigating possible high-voltage failures. It should be appreciated that a single insulative portion 620a or 620b may be used instead of relying upon a set of insulative portions. Moreover, the insulative portions 620a and/or 620b may wrap over the top and/or bottom surfaces of the boding pads 616 in addition to wrapping over the side surface of the bonding pads 616. It should also be appreciated that the material used for the insulative portions 620a, 620b may be similar or identical to the material discussed in connection with other insulative tapes disclosed herein.

Although not depicted, the opto-coupler component 600 may also comprise an encapsulant that covers the optical components 624, 628, the wire bonds 632, and the insulative portions 620a, 620b. In this embodiment, however, the insulative portions 620a, 620b are designed to mitigate arcing between the leadframe portions 608a, 608b instead of control the shape of the encapsulant in a liquid or semi-liquid state.

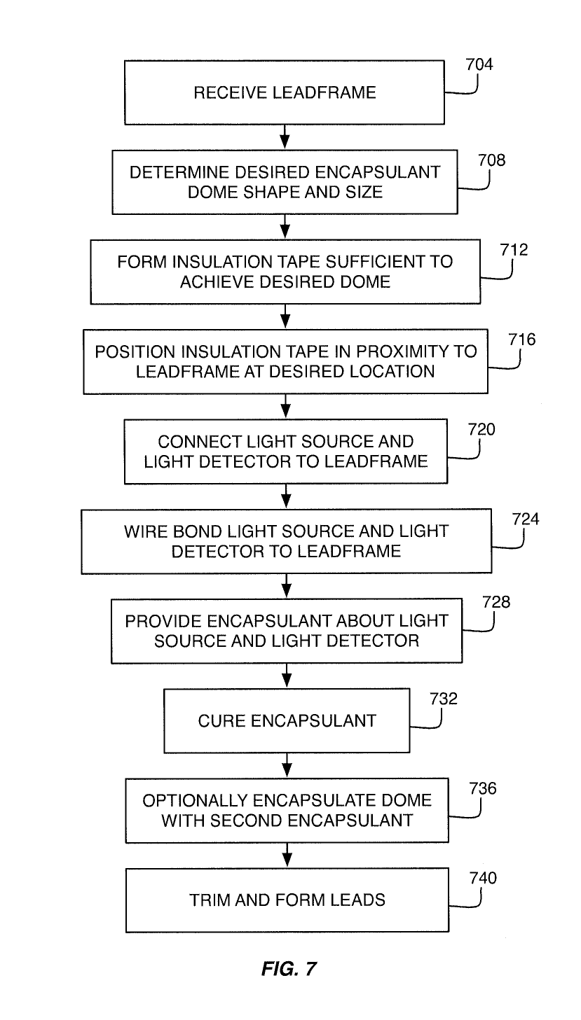

With reference now to FIG. 7, a method of constructing an opto-coupler 100 or any of the intermediate opto-coupler components 200, 300, 400, 500, 600 will be described in accordance with at least some embodiments of the present disclosure. Although the method will be particularly related to the construction of a single-channel opto-coupler, it should be appreciated that the method may easily be extended to the construction of multi-channel opto-couplers and opto-coupler components without departing from the scope of the present disclosure.

The method begins when a leadframe is received (step 704). The received leadframe may comprise multiple leads, some designed for an input side and some designated for an output side. In some embodiments, the leadframe may be received in a sheet-like format with features cut therefrom to at least partially establish the lead(s) and mounting section(s) of the leadframe. As can be appreciated, the leads of the leadframe may need to be bent of formed to accommodate the specific type of opto-coupler desired. This bending or folding may be performed at any point during the manufacturing process, but it should be noted that the leadframe may be received with or without the bends to the leads.

After the leadframe is received, the method continues by determining a desired encapsulant dome shape and size (step 708). The desired dome shape and size may be selected to accommodate a particular use-case for the opto-coupler. In some embodiments, the dome shape may be desired to have an elliptical cross section whereas other embodiment may require the dome shape to have a circular cross section.

The insulative tape is then formed according to the desired dome shape and size (step 712). In particular, the insulative tape may correspond to the lone mechanism that is used to form the encapsulant or maintain the encapsulant in a desired shape until it is cured or hardened. Any shape of insulative tape or insulative portion described herein may be utilized without departing from the scope of the present disclosure. The insulative tape or insulative tapes (e.g., additional insulative tape) are then positioned in proximity to the leadframe at the desired locations (step 716). This step may also include the process of attaching or adhering the insulative tape to the top, bottom, and/or side surfaces of the leadframes. Specifically, the insulative tape may be attached with an adhesive underneath the bonding pads, on top of the bonding pads, and/or on the side surfaces of the bonding pads.

Before, after, or simultaneous with any of steps 708, 712, and 716, the optical components may also be attached to the bonding pads of the opto-coupler (step 720). In some embodiments, these optical components may be attached to the leadframe using adhesives or the like, although such a configuration is not mandatory. The light source(s) and light detector(s) may then be electrically connected to the leadframe (step 724), if this was not already inherently done by virtue of mounting the components to the leadframe. Specifically, this step may involve connecting the light source(s) and/or light detector(s) to leads of the leadframe with one or more wire bonds.

Once the optical components are positioned and electrically connected as necessary, the method may proceed with the deposition of the encapsulant about the optical component(s), their wire bonds, and the bonding pads (step 728). In some embodiments, the encapsulant is deposited in a liquid or semi-liquid state. The types of processes that may be used to deposit the encapsulant include any type of known deposition technique such as those described in U.S. Patent Publication No. 2013/0102096, the entire contents of which are hereby incorporated herein by reference.

In some embodiments, the encapsulant flows to one, some, or all of the outermost boundaries of the insulative tape under the force of gravity. This flowing occurs until the liquid or semi-liquid encapsulant maintains an equilibrium between its inherent surface tension and the gravitational forces. The encapsulant may then be cured or hardened (step 732). The curing step may vary depending upon the type of encapsulant used. Examples of suitable curing or hardening steps include chemical curing, thermal curing, UV curing, air curing, or the like.

Once cured, the encapsulant may optionally be encapsulated or covered with a second encapsulant, such as housing 104 (step 736). In particular, a mold material or compound may be applied to the optical components and portions of the leadframe as well as the now-cured encapsulant protecting the optical components, thereby encapsulating the optical components within the mold material.

The method continues with one or more trimming and/or forming steps (step 740). In these trimming steps, the leads of the leadframe may be further defined and/or separated from one another. Furthermore, the trimming may involve removing leadframe material so as to appropriate size the leads of the lead frame to interface with a PCB, for instance. The forming steps (e.g., bending steps) may be performed to achieve a completed opto-coupler. Specifically, the finally formed or trimmed leads may be bent such that the opto-coupler is easily inserted into or mounted on a PCB or the like.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. An opto-coupler device, comprising:
a first leadframe section having a first lead;
a second leadframe section having a second lead and being electrically separated from the first leadframe section;
a light source configured to emit light according to electrical signals received from at least one lead of the first leadframe section, the light source further being supported by a bonding pad of the first lead;
a light detector configured to detect light emitted by the light source and convert the detected light into electrical signals for transmission by at least one lead of the second leadframe section, wherein the light detector is supported by a bonding pad of the second lead;
an insulative tape positioned in proximity to the bonding pad of the first and the bonding pad of the second lead, wherein the insulative tape comprises a selected shape; and
an optically-transparent encapsulant provided about the light source and light detector and being further supported by the insulative tape, wherein a shape of the optically-transparent encapsulant is at least partially dictated by the selected shape of the insulative tape and gravity.

2. The opto-coupler device of claim 1, wherein the shape of the optically-transparent encapsulant is solely dictated by the selected shape of the insulative tape and gravity.

3. The opto-coupler device of claim 2, wherein an outer boundary of the optically-transparent encapsulant at least partially coincides with an outer boundary of the insulative tape.

4. The opto-coupler device of claim 3, wherein the outer boundary of the optically-transparent encapsulant completely coincides with the outer boundary of the insulative tape and wherein surface tension of the optically-transparent encapsulant equalizes with gravitational forces to enable formation of the optically-transparent encapsulant into the shape.

5. The opto-coupler device of claim 1, wherein a height of the optically-transparent encapsulant is less than or equal to a smallest width of the insulative tape.

6. The opto-coupler device of claim 1, wherein the optically-transparent encapsulant corresponds to a curable material that is deposited in at least one of a liquid and semi-liquid state.

7. The opto-coupler device of claim 6, wherein the optically-transparent encapsulant comprises at least one of epoxy, silicone, a hybrid of silicone and epoxy, phosphor, a hybrid of phosphor and silicone, an amorphous polyamide resin or fluorocarbon, glass, and plastic.

8. The opto-coupler device of claim 1, wherein an adhesive of the insulative tape at least partially adheres the insulative tape to the first leadframe section and second leadframe section.

9. The opto-coupler device of claim 8, wherein the insulative tape is adhered to a bottom surface of the first leadframe section and a bottom surface of the second leadframe section and wherein the optically-transparent encapsulant is deposited on the adhesive of the insulative tape.

10. The opto-coupler device of claim 8, wherein the insulative tape is attached to a top surface of the first leadframe section and a top surface of the second leadframe section.

11. The opto-coupler device of claim 8, wherein the insulative tape is at least partially attached to a side surface of at least one of the first leadframe section and second leadframe section.

12. The opto-coupler device of claim 1, wherein the insulative tape comprises at least one of a polyimide film, a plastic tape, and a dielectric tape.

13. The opto-coupler device of claim 1, further comprising:
a housing which completely encloses the optically-transparent encapsulant and substantially inhibits external light from reaching the optically-transparent encapsulant.

14. An isolator, comprising:
an input lead comprising a bonding pad;
an output lead comprising a bonding pad;
a light source mounted on the bonding pad of the input lead;
a light detector mounted on the bonding pad of the output lead;
an insulative tape positioned in proximity to a bottom surface of the input lead and a bottom surface of the output lead; and
an optically-transparent encapsulant deposited on the insulative tape such that a dome shape formed by the optically-transparent encapsulant is dictated by a shape of the insulative tape.

15. The isolator of claim 14, wherein the insulative tape comprises at least one of a circular, elliptical shape, and polygonal shape.

16. The isolator of claim 14, wherein the insulative tape impedes a high-voltage failure path between the input lead and the output lead.

17. The isolator of claim 14, wherein an outer boundary of the optically-transparent encapsulant substantially coincides with an outer boundary of the insulative tape

18. The isolator of claim 14, further comprising a plurality of channels, at least one of the plurality of channels comprising the light guide and the light source.

19. A method of manufacturing an optical device, the method comprising:
receiving a leadframe;
determining a desired encapsulant dome shape and size;
forming insulative tape sufficient to achieve the desired dome shape and size;
positioning the insulative tape in proximity to the leadframe; and
depositing at least one of a liquid and semi-liquid encapsulant on the insulative tape; and
allowing the encapsulant to flow to one or more boundaries of the insulative tape to achieve the desired dome shape and size.

20. The method of claim 19, wherein gravitational forces and inherent surface tension of the encapsulant equalize while the encapsulant is still in the liquid or semi-liquid state, the method further comprising:
curing the encapsulant after the gravitational forces and inherent surface tension of the encapsulant has equalized.
